(19) United States
(12) Patent Application Publication
(10) Pub. No.: US 2019/0367418 A1
(43) Pub. Date: Dec. 5, 2019

(54) CMC MANUFACTURING WITH A MOLD

(71) Applicant: Rolls-Royce High Temperature Composites Inc., Cypress, CA (US)

(72) Inventor: Stephen Harris, Long Beach, CA (US)

(73) Assignee: Rolls-Royce High Temperature Composites Inc., Cypress, CA (US)

(21) Appl. No.: 16/000,085

(22) Filed: Jun. 5, 2018

(51) Int. Cl. C04B 35/80; C04B 40/02; C04B 41/00

(52) U.S. Cl. CPC C04B 35/80; C04B 2111/00931; C04B 41/0018; C04B 40/0295

(57) ABSTRACT

A porous fiber preform enclosed within a mold may be melt infiltrated by pouring a molten material through an inlet of the mold, the porous fiber preform comprising ceramic fibers. A ceramic matrix composite component comprising the ceramic fibers may be formed by solidifying the molten material that is in the mold and in the porous fiber preform.

### TECHNICAL FIELD

This disclosure relates to ceramic matrix composites and, in particular, to the manufacturing of ceramic matrix composite components

### BACKGROUND

Ceramic matrix composites (CMCs), which include ceramic fibers embedded in a ceramic matrix, exhibit a combination of properties that make CMCs promising candidates for industrial applications that demand excellent thermal and mechanical properties along with low weight, such as gas turbine engine components.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a cross-sectional view of an example of a mold in use during melt infiltration of a porous fiber preform;

FIG. 2 illustrates a flow diagram of an example of steps to manufacture and/or form a ceramic matrix composite component; and

FIG. 3 is a schematic representation of a continuous reactor or furnace in which the solidification of molten material includes moving a solidification front within the molten material.

### DETAILED DESCRIPTION

By way of an introductory example, a method of forming a ceramic matrix composite (CMC) component is described. A porous fiber preform, which comprises ceramic fibers, may be positioned in a cavity defined by an inner surface of a mold, where the mold includes an inlet into the cavity. The porous fiber preform may be slurry infiltrated while in the mold. In addition, the porous fiber preform may be melt infiltrated by pouring a molten material through the inlet of the mold into the cavity. The molten material is solidified, where the inner surface of the mold matches an outer surface of the CMC component after the molten material is solidified.

One interesting feature of the innovative methods described herein may be that the outer surface of the CMC component, which matches the inner surface of the mold, may not have a woven surface topography that is typically present in the initial preform. In contrast, using other methods of manufacturing, the woven surface topography of the initial preform tends to persist in the surface of a melt infiltrated component. As result, the methods described herein may result in a smoother outer surface of the CMC component. The smoother outer surface of the CMC component may improve manufacturing tolerances and aero performance in CMC jet engine turbine components.

Alternatively, or in addition, an interesting feature of the methods described below may be that the melt infiltration may be more effective than other approaches. For example, a common end-wicking melt-infiltration process becomes less effective as the level of reactive material in the slurry is increased due to volumetric expansion and “choking” of melt capillaries. This “choking” of melt capillaries limits the amount of reactive elements that may otherwise be added to the slurry and leads to excessive residual silicon in the melt-infiltrated CMC component.

Alternatively, or in addition, an interesting feature of the methods described below may be to limit residual silicon “nodules” caused by volumetric expansion of silicon upon solidification of the molten material. In the innovative methods described herein, the volumetric expansion of silicon upon solidification may force a portion of the molten silicon to expand into outlets of the mold, thereby directing the excess silicon to the outlets of the mold.

The present disclosure generally provides a method of producing a ceramic matrix composite (CMC). CMCs are generally made from a lay-up of a plurality of continuous ceramic fibers, formed to a desired shape. At this stage in the production of a CMC component, the lay-up is generally known as a ceramic fiber preform, fiber preform, or preform. The fiber preform, which may be partially-rigid or non-rigid, may be constructed in any number of different configurations. For example, the preform may be made of filament windings, braiding, and/or knotting of fibers, and may include two-dimensional and three-dimensional fabrics, unidirectional fabrics, and/or nonwoven textiles. For example, forming the preform may include laying up stacked two-dimensional cloth or three-dimensional laminates. The fibers used in the preform, furthermore, may comprise any number of different materials capable of withstanding the high processing temperatures used in preparing and operating CMCs, such as, but not limited to, carbon fibers, ceramic fibers (for example, silicon carbide, alumina, mullite, zirconia, or silicon nitride), which can be crystalline or amorphous. The ceramic fibers may be suitably coated by various methods.

During preparation of the CMC, the preform can be infiltrated with a matrix precursor material. The matrix precursor material can comprise any number of materials such as, but not limited to, polymers, metals, and ceramics, including without limitation silicon, silicon carbide, alumina, mullite, zirconia, and combinations thereof (e.g., silicon/silicon carbide, etc.). In most embodiments, the matrix precursor material comprises ceramic particles. The preform can be infiltrated with the matrix precursor material using any number of processes, for example by infiltration of the preform with a slurry of the matrix precursor material under elevated or reduced pressure, by chemical vapor deposition or chemical vapor infiltration, by pyrolysis (for example, of a pre-ceramic polymer), by chemical reactions, sintering, melt infiltration, and electrophoretic deposition (e.g., of a ceramic powder). Finally, the CMC may be machined, if necessary to bring the geometry of the part into the required specifications.

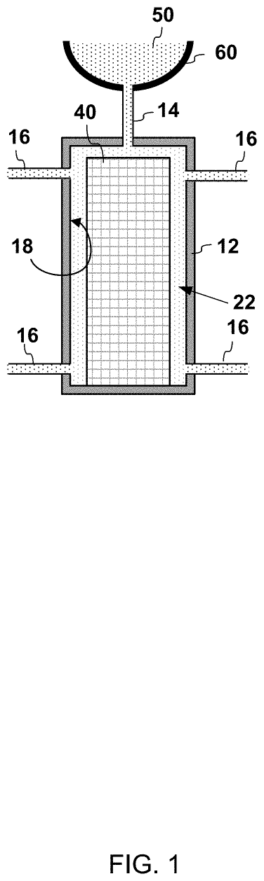

FIG. 1 is a cross-sectional view of an example of a mold 12 in use during melt infiltration of a porous fiber preform 40. The example of the mold 12 includes an inlet 14, outlets 16, and an inner surface 18. The inner surface 18 defines a cavity 22 in which the porous fiber preform 40 has been positioned. A crucible 60 holds a molten material 50, such as molten silicon.

The porous fiber preform 40 is melt infiltrated by pouring the molten material 50 through the inlet 14 of the mold 12 into the cavity 22 where the porous fiber preform 40 is located. Air or other gas that may be in cavity 22 is displaced and forced through the outlets 16 by the incoming molten material 50. The molten material 50 may surround or partially surround the porous fiber preform 40. When pouring the molten material 50 through the inlet 14, gravitational forces pull the molten material 50 through the inlet 14 instead of capillary forces. Once the molten material 50 enters the cavity 22 and comes into contact with the porous fiber preform 40, capillary forces may pull the molten material 50 into the preform 40.

The mold 12 may be made of, for example, boron nitride, graphite, silicon, silicon nitride, and/or any other material that can withstand the temperature of the molten material 50. The mold 12 illustrated in FIG. 1 includes only one inlet 14. The mold 12 may include additional inlets. Alternatively or in addition, the mold 12 may include zero or more outlets 16 through which a gas in the cavity 22, such as air, may be displaced by the molten material 50 that enters the cavity 22. Alternatively or in addition, the mold 12 may include any number of gates, sprues, flow passages, cavities, spouts, and/or passageways. The mold 12 may include a refractory tool.

The cross-section of the mold 12 shown in FIG. 1 is a rectangle. However, in other examples, the mold 12 may have any shape, simple or complex. The cavity of the mold 12 may correspond to a target final shape of the ceramic matrix composite component or a portion thereof.

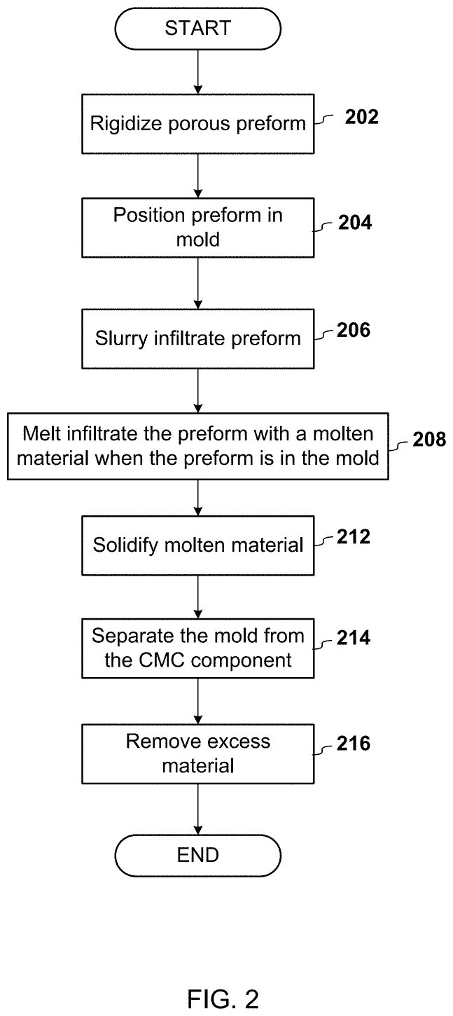

FIG. 2 illustrates a flow diagram of an example of steps to manufacture and/or form a ceramic matrix composite component. Operations may begin by rigidizing (202) the porous fiber preform 40 through, for example, chemical vapor deposition (CVD) or chemical vapor infiltration (CVI).

The porous fiber preform 40, which comprises ceramic fibers (represented as a grid pattern in FIG. 1), may be positioned (204) in the cavity 22 defined by the inner surface 18 of the mold 12.

The porous fiber preform 40 may be slurry infiltrated (206). For example, slurry infiltrating (206) the preform 40 may include vacuum or pressure infiltrating the porous fiber preform 40 with a ceramic slurry. As shown in FIG. 2, the preform 40 may be slurry infiltrated (206) after the preform 40 is positioned in the mold 12. The porous fiber preform 40 may become less porous as a result of the slurry infiltration (206). In some examples, slurry infiltrating (206) the preform 40 may include cleaning the residual slurry from the component. Alternatively, the preform 40 may not need to be cleaned, particularly, if the preform 40 has a relatively uniform surface.

The porous fiber preform 40 may be melt infiltrated (208) by pouring the molten material 50 through the inlet 14 of the mold 12 into the cavity 22. Any air or other gas that may be in cavity 22 may be forced through one or more of the outlets 16 by the incoming molten material 50. Alternatively, the cavity 22 may be evacuated before pouring the molten material into the cavity 22 containing the preform 40. The molten material 50 may surround or partially surround the porous fiber preform 40. Capillary forces may pull the molten material 50 into the preform 40.

The molten material 50 may be solidified (212). For example, the molten material 50 may be allowed to cool and/or is cooled. The inner surface 18 of the mold 12 may dictate the shape of an outer surface of a ceramic matrix composite component formed upon the solidification of the molten material 50. A portion of the molten material 50 may expand, during the solidification of the molten material 50, into one or more passages of the mold 12, such as the outlets 16 and/or the inlet 14.

The mold 12 may be separated (214) from the ceramic matrix composite component. For example, the mold 12 may open in a clamshell fashion and the mold 12 removed. Alternatively or in addition, the ceramic matrix composite component may be extracted from the mold 12.

Any excess material may be removed (216) from the ceramic matric component. For example, a final step may include removing regions of the ceramic matrix composite component that formed in gates, cavities in the mold 12, or in any other areas that may be required only for flow of the molten material 50 during the melt infiltration. The excess material may be machined off, for example. When desirable, one or more finishing operations may be performed on the CMC component. These finishing operations may include, but not be limited to, grinding, sanding, cutting, trimming, densification, brazing, or surface treatment, to name a few.

The steps may include additional, different, or fewer operations than illustrated in FIG. 2. For example, the steps may only include a subset of those shown. In one such example, the steps may include only melt infiltrating (208) the porous fiber preform 40 positioned in the mold 12 and solidifying (212) the molten material 50. In yet another such example, the steps may include only slurry infiltrating (206) the porous fiber preform 40 positioned in the mold 12, melt infiltrating (208) the porous fiber preform 40 positioned in the mold 12, and solidifying (212) the molten material 50.

In FIG. 2, the mold 12 in which the porous fiber preform 40 is melt infiltrated (208) is the same as the mold 12 in which the preform 40 is slurry infiltrated (206). However, in other example, the preform 40 is slurry infiltrated (206) in a first mold, and then subsequently melt infiltrated (208) in a second mold.

In some examples, the melt infiltration (208) of the porous fiber preform 40 in the mold 12 may be combined with other melt infiltration techniques. For example, a bottom of the porous fiber preform 40 may rest on a wick and be melt-infiltrated with the wick while the rest of the preform 40 is melt infiltrated in the mold 12.

Melt infiltrating (208) the porous fiber preform 40 in the mold 12 may increase the effectiveness of a directional solidification approach employed during the solidification (212) of the molten material 50. The directional solidification approach is explained in U.S. non-provisional patent application Ser. No. 15/967,664, filed May 1, 2018, and entitled “DISCRETE SOLIDIFICATION OF MELT INFILTRATION”, which is hereby incorporated by reference. If a term set forth in this application is contrary to or otherwise inconsistent with a term set forth in patent application 15/967,664 that is herein incorporated by reference, the term set forth in this application prevails over the term that is incorporated herein by reference.

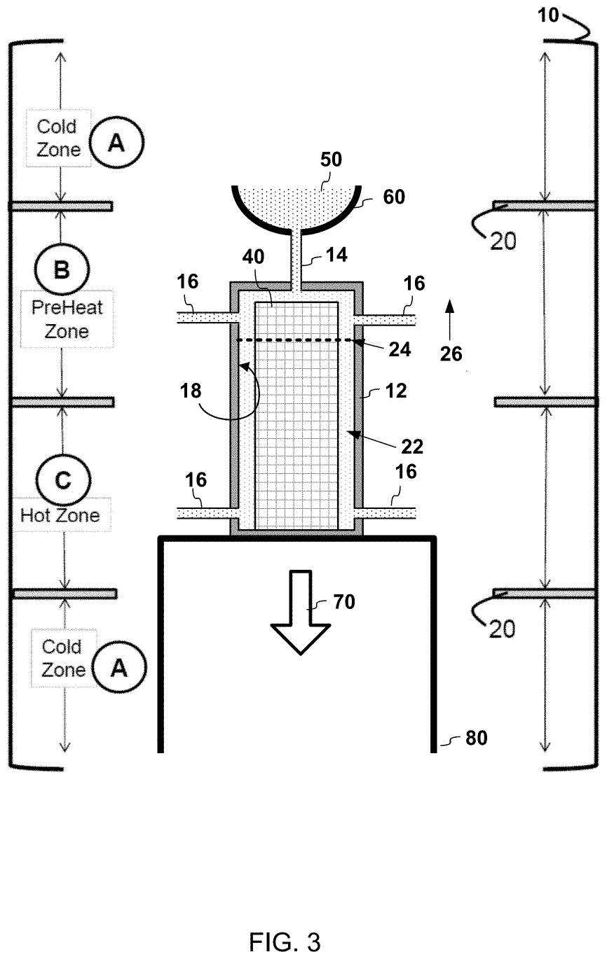

FIG. 3 is a schematic representation of a continuous reactor or furnace 10 that highlights specific aspects of a process in which the solidification (212) of the molten material 50 includes moving a solidification front 24 within the molten material 50. The solidification front 24 is formed and moved by forming and moving a temperature gradient in a direction 26 that the solidification front 24 is to move. The porous fiber preform 40 is first melt infiltrated (208) with the molten material 50 while the preform 40 is in the mold 12. The mold 12 is on a means 80 capable of moving or transferring an assembly that comprises, for example, the mold 12, the porous fiber preform 40, the crucible 60, and the molten material 50. The means 80 may be configured to move the assembly through various zones of the reactor or furnace 10. The reactor or furnace 10 may comprise, for example, (A) at least one cold zone, (B) at least one preheat zone, and (C) at least one hot zone. Each of the zones (A, B, C) may be separated by at least one thermal barrier or baffle 20. Each of the zones (A, B, C) may be capable of being, for example, placed under a vacuum, heated, and/or chilled. The baffles 20 are capable of maintaining the prescribed temperature difference over a distance of, for example, less than 6 inches; alternatively, over a length of less than 3 inches; alternatively, over a length of less than 1 inch.

The means 80 capable of moving the assembly may move the assembly in a direction 70 of travel. In the example shown in FIG. 3, as the means 80 moves the assembly in the direction 70 of travel, the assembly moves through a first cold zone (A), a preheat zone (B), a hot zone (C), and a second cold zone (B). The means 80 may include a lift, a material elevator, a conveyor, a vertical reciprocating conveyor, and/or any other device for moving material.

As the ceramic matrix composite is gradually cooled to ambient or room temperature as the assembly is moved in the direction 70 of travel by the means 80 for moving the assembly, the solidification front 24 is formed and moved through the resulting ceramic matrix composite. The solidification front 24 may move from the top to the bottom of the ceramic matrix composite or, as shown in FIG. 3, in the direction 26 from the bottom to the top of the ceramic matrix composite. More specifically, as the temperature of a region of the ceramic matrix composite begins to cool (for example, lower temperature), the solidification front 24 moves towards the region of the ceramic matrix composite that is at a higher temperature.

Forming and moving the solidification front 24 may have a benefit of lowering impurities arising from the molten material 50 and/or melt additives included in the molten material 50. The overall level of impurities arising from the infiltration of the molten metal or alloy may be, for example, less than 30 ppm; alternatively, less than 20 ppm; alternatively, less than 10 ppm. The impurities may comprise metal or nonmetallic elements, including without limitation, aluminum, iron, titanium, calcium, boron, and phosphorous, to name a few. The solidification front 24 may be moved toward a target area, such as the inlet 14 of the mold 12, the outlets 16 of the mold 12, any opening in the mold 12, and/or any select surface of the ceramic matrix composite, where the impurities may be subsequently removed relatively easily. For example, if the solidification front 24 is moved to a passageway such as the inlet 14, impurities in the molten material 50 may be moved into the passageway. After the molten metal 50 has been solidified, the solidified portion of the molten material 50 in the passageway may be removed along with the impurities that were forced into the passageway by the solidification front 24.

The steps may be executed in a different order than illustrated in FIG. 2. For example, the steps may include slurry infiltrating (206) the porous fiber preform before the porous fiber preform 40 is positioned (204) in the mold 12. In some examples, the steps may include centrifuging the porous fiber preform 40 and/or the mold 12 while the molten material 50 is in the mold 12. Centrifuging the porous fiber preform 40 may improve the infiltration of the molten material 50 into the porous fiber preform 40 in some arrangements.

In some examples, the mold 12 may be constructed by applying a fugitive polymer to one or more surfaces of the porous fiber preform 40 following the slurry infiltration (206) in order to seal the periphery of the porous fiber preform 40 or a portion of the periphery of the porous fiber preform 40. In addition, any needed passageways, such as flow passages and/or vents, may be incorporated by adding the fugitive polymer in the corresponding locations. The resultant structure enables a “lost wax” or “investment” casting process to form the mold 12 in which the porous fiber preform 40 may be positioned and infiltrated during the melt infiltration (208). In other words, the mold 12 may be created around the porous fiber preform 40 and the fugitive polymer that was applied to the preform 40; and the fugitive polymer may be removed by, for example, pyrolysis or melting, thereby leaving the mold 12 and the porous fiber preform 40, which subsequently may be melt infiltrated (208) within the mold 12.

Referring now to both FIGS. 1 and 2, the porous fiber preform 40 may comprise a plurality of fibers that are made from any inorganic material stable at processing temperatures above about 1,000° C. and compatible with the temperature of the molten metal or alloy used to infiltrate the pores or free volume in the porous fiber preform 40. The plurality of fibers, in some examples, may be woven into a shape that resembles the ceramic matrix composite (CMC) to be produced. Several specific examples of fibers include, without limitation, silicon carbide (SiC) fibers, silicon nitride fibers, alumina fibers, mullite fibers, zirconia fibers, carbon or graphite fibers, or a combination thereof. Alternatively, the fibers are SiC fibers, such as those commercially available under the designation Hi-Nicalon fibers and SYLRAMIC® fibers (registered trademark of COI Ceramics, Inc., San Diego, Calif.). The ceramic fibers may include chopped fibers, continuous fibers, woven fabrics or combinations thereof that are laid up, fixed, and shaped into the configuration of a desired component.

In some examples, the porous fiber preform 40 may further comprise other additives or processing aids. For example, the inorganic fibers in the preform 40 may be treated by applying a coating or coatings to provide a compliant layer at the interface between the fibers and the matrix material composed of subsequently introduced particles or components of the molten material 50. Examples of the molten material 50 may include molten metal or metal alloy infiltrant. This compliant layer may enhance the toughness of and crack deflection in the final ceramic matrix composite (CMC) and/or act as a barrier layer to prevent reaction of the reinforcing fibers with the molten metal or alloy infiltrant. Suitable coatings include, but are not limited to, carbon, aluminum nitride, boron nitride, silicon doped boron nitride, silicon nitride, silicon carbide, boron carbide, metal borides, transition metal silicides, transition metal oxides, transition metal silicates, rare earth metal silicates and mixtures and combinations thereof. If used, in various embodiments the fiber coating may have a thickness of about 0.05 micrometers (μm) to 3 μm, alternatively, about 0.1 μm to about 1 μm. A coated fiber preform may further include rigidization with a ceramic material accomplished through the use of any conventional methods, including without limitation, chemical vapor infiltration with silicon carbide, silicon nitride, or the like. In some examples, the fibers may be oxide fibers and the ceramic matrix composite may be an oxide-oxide ceramic matrix composite.

The ceramic fibers in the preform 40 may include individual fiber filaments or a bundle and/or a tow of filaments. The filaments in each bundle or tow may be braided or otherwise arranged. Each of the fibers is individually selected and may be of the same or different composition and/or diameter. Alternatively, the fibers are the same in at least one of said composition and/or diameter. The ceramic fiber filaments may have a diameter that is between about 1 micrometer (μm) to about 200 μm; alternatively, about 3 μm to about 100 μm; alternatively, about 5 μm to about 30 μm; alternatively, about 10 μm to about 20 μm.

As used herein the term “metal or alloy” is intended to refer to the main matrix infiltrant, which may comprise any number of materials such as, but not limited to, polymers, metals, and ceramics. Several specific examples of metals that may be used to slurry infiltrate the fiber preform may comprise, without limitation, aluminum, silicon, nickel, titanium, or mixtures and alloys thereof. Several specific examples of ceramics that may be used to melt infiltrate the fiber preform may include, without limitation, silicon, alumina, mullite, zirconia, and combinations thereof. Alternatively, the metal or alloy infiltrant may react upon infiltration to form additional ceramic phases that were not introduced as a slurry (e.g., silicon carbide). The metal or alloy may be initially provided in any physical form, including, but not limited to powders, particles, or lumps. When desirable, the metal or alloy particles may be combined with other additives or process aids used in forming the molten metal bath.

To clarify the use of and to hereby provide notice to the public, the phrases “at least one of <A>, <B>, . . . and <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:
1. A method of forming a ceramic matrix composite component, the method comprising:

positioning a porous fiber preform, which comprises a plurality of ceramic fibers, into a cavity defined by an inner surface of a mold, the mold including an inlet into the cavity;

melt infiltrating the porous fiber preform by pouring a molten material through the inlet of the mold into the cavity; and

solidifying the molten material, wherein the inner surface of the mold corresponding to an outer surface of the ceramic matrix composite component after the molten material is solidified.
2. The method of aspect 1 further comprising removing the mold from the ceramic matrix composite component.
3. The method of any of aspects 1 to 2 further comprising slurry infiltrating the porous fiber preform before the melt infiltrating and after the porous fiber preform is positioned in the cavity defined by the inner surface of the mold.
4. The method of any of aspects 1 to 3, wherein the mold comprises a passage through which a portion of the molten material expands during the solidifying.
5. The method of any of aspects 1 to 4, wherein the solidifying the molten material comprises moving a solidification front in a direction by forming a temperature gradient.
6. The method of aspect 5, wherein the moving the solidification front comprises moving the solidification front toward an opening in the mold.
7. The method of any of aspects 5 to 6, wherein the moving the solidification front causes impurities and/or melt additives to move toward a target area of the mold.
8. The method of any of aspects 1 to 7, wherein the mold comprises boron nitride, graphite, or silicon.
9. The method of any of aspects 1 to 8, wherein the mold includes a gate, a sprue, a flow passage, and/or a spout.
10. The method of any of aspects 1 to 9, wherein the molten material includes silicon.
11. The method of any of aspects 1 to 10 further comprising removing any excess material from the ceramic matric component.
12. A method comprising:

melt infiltrating a porous fiber preform enclosed within a mold by pouring a molten material through an inlet of the mold, the porous fiber preform comprising ceramic fibers; and

forming a ceramic matrix composite component comprising the ceramic fibers by solidifying the molten material that is in the mold and in the porous fiber preform.
13. The method of aspect 12 further comprising slurry infiltrating the porous fiber preform after the porous fiber preform is positioned in the mold and before the melt infiltrating.
14. The method of any of aspects 12 to 13, wherein the mold comprises a passageway through which a portion of the molten material expands during the solidifying.
15. The method of any of aspects 12 to 14, wherein the solidifying the molten material comprises moving a solidification front into a passageway of the mold.
16. The method of any of aspects 12 to 15, wherein the solidifying the molten material comprises moving a solidification front toward a target area of the mold, wherein the moving the solidification front causes impurities and/or melt additives to move toward the target area of the mold.
17. The method of any of aspects 12 to 16, further comprising removing a solidified portion of the molten material that solidified in a passageway of the mold.
18. The method of any of aspects 12 to 17 further comprising:

applying a fugitive polymer to the porous fiber preform after slurry infiltrating the porous fiber preform;

creating the mold around the porous fiber preform and the fugitive polymer that was applied to the porous fiber preform; and

removing the fugitive polymer from around the porous fiber preform before the melt infiltrating.

19. The method of any of aspects 12 to 18 further comprising, prior to the creating the mold, adding the fugitive polymer to a location at which a passageway in the mold is to be formed.
20. The method of any of aspects 12 to 19 further comprising centrifuging the porous fiber preform and/or the mold while the molten material is in the mold.

What is claimed is:

1. A method of forming a ceramic matrix composite component, the method comprising:
positioning a porous fiber preform, which comprises a plurality of ceramic fibers, into a cavity defined by an inner surface of a mold, the mold including an inlet into the cavity;
melt infiltrating the porous fiber preform by pouring a molten material through the inlet of the mold into the cavity; and
solidifying the molten material, wherein the inner surface of the mold corresponding to an outer surface of the ceramic matrix composite component after the molten material is solidified.

2. The method of claim 1 further comprising removing the mold from the ceramic matrix composite component.

3. The method of claim 1 further comprising slurry infiltrating the porous fiber preform before the melt infiltrating and after the porous fiber preform is positioned in the cavity defined by the inner surface of the mold.

4. The method of claim 1, wherein the mold comprises a passage through which a portion of the molten material expands during the solidifying.

5. The method of claim 1, wherein the solidifying the molten material comprises moving a solidification front in a direction by forming a temperature gradient.

6. The method of claim 5, wherein the moving the solidification front comprises moving the solidification front toward an opening in the mold.

7. The method of claim 5, wherein the moving the solidification front causes impurities and/or melt additives to move toward a target area of the mold.

8. The method of claim 1, wherein the mold comprises boron nitride, graphite, or silicon.

9. The method of claim 1, wherein the mold includes a gate, a sprue, a flow passage, and/or a spout.

10. The method of claim 1, wherein the molten material includes silicon.

11. The method of claim 1, further comprising removing any excess material from the ceramic matric component.

12. A method comprising:
melt infiltrating a porous fiber preform enclosed within a mold by pouring a molten material through an inlet of the mold, the porous fiber preform comprising ceramic fibers; and
forming a ceramic matrix composite component comprising the ceramic fibers by solidifying the molten material that is in the mold and in the porous fiber preform.

13. The method of claim 12 further comprising slurry infiltrating the porous fiber preform after the porous fiber preform is positioned in the mold and before the melt infiltrating.

14. The method of claim 12, wherein the mold comprises a passageway through which a portion of the molten material expands during the solidifying.

15. The method of claim 12, wherein the solidifying the molten material comprises moving a solidification front into a passageway of the mold.

16. The method of claim 12, wherein the solidifying the molten material comprises moving a solidification front toward a target area of the mold, wherein the moving the solidification front causes impurities and/or melt additives to move toward the target area of the mold.

17. The method of claim 12, further comprising removing a solidified portion of the molten material that solidified in a passageway of the mold.

18. The method of claim 12 further comprising:
applying a fugitive polymer to the porous fiber preform after slurry infiltrating the porous fiber preform;
creating the mold around the porous fiber preform and the fugitive polymer that was applied to the porous fiber preform; and
removing the fugitive polymer from around the porous fiber preform before the melt infiltrating.

19. The method of claim 18 further comprising, prior to the creating the mold, adding the fugitive polymer to a location at which a passageway in the mold is to be formed.

20. The method of claim 12 further comprising centrifuging the porous fiber preform and/or the mold while the molten material is in the mold.
